(19) United States
(12) Patent Application Publication
(10) Pub. No.: US 2015/0305259 A1
(43) Pub. Date: Oct. 29, 2015

(54) DEVICE FOR DOMESTIC HYDROPONIC CULTIVATION

(71) Applicant: GALAXY COLOR S.r.l., Milano (IT)

(72) Inventor: Richard Mario Harley GALASSI, Milano (IT)

(21) Appl. No.: 14/647,374

(22) PCT Filed: Nov. 28, 2013
(86) PCT No.: PCT/IB2013/060482

§ 371 Date: May 26, 2015

(30) Foreign Application Priority Data
Nov. 30, 2012 (IT) MI2012A002055

(51) Int. Cl. A01G 31/02; A01G 7/04

(52) U.S. Cl. CPC A01G 31/02; A01G 7/045

(57) ABSTRACT

A device (1) for domestic hydroponic cultivation, comprising a reservoir (3) for containing a nutrient fluid for at least one plant and that is positioned at a predetermined reference height (Qref); a support (2) configured to receive the at least one plant and removably associated with the upper part of the reservoir (3) at a first height (Q1) that is higher than the predetermined reference height (Qref); a pump (22) associated with the reservoir (3) and positioned at a second height (Q2) that is higher than the first height (Q1) and the predetermined reference height (Qref); a bubbler (23) associated with the support (2) substantially at the first height (01); lighting means (6) associated with the support (2), configured to illuminate the at least one plant and comprising a plurality of LEDs (13, 14).

The object of the present invention is a device for domestic hydroponic cultivation. In fact, this device is can be used for the hydroponic cultivation of plants for food or ornamental purposes in indoor environments, including for example homes, apartments, coffee shops, restaurants, offices, public places, or other environments.

Hydroponic cultivation is known in the state of the art, that is to say, a soil-less cultivation technique in which earth is substituted by an inert substratum (expanded clay, perlite, vermiculite, coconut fibre, rock wool, zeolite, etc.). Specifically, the plant is irrigated with a nutrient solution in which the minerals required for growth of the specific plant to be cultivated are dissolved. Hydroponic cultivation enables year-round controlled crop production, in terms of quality and health and hygienic standards.

One particular type of hydroponic cultivation is the so-called “deep water culture” (DWC), in which the roots of the plant are suspended in the solution containing the nutrients.

In the state of the art, there are also known devices for hydroponic cultivation in indoor environments. These devices comprise a support that is suitable for receiving and supporting a plant. A reservoir containing a nutrient fluid is associated with the support. Specifically, the roots of the plant can be directly immersed in the reservoir or as in most of the known devices, they can be immersed in a tank in which the nutrient fluid coming from the reservoir circulates. For operation in environments with reduced light, the device comprises one or more lights arranged so as to illuminate the support and the plant being cultivated.

The known devices are predisposed so as to ensure that a professional farmer has the possibility of adapting at will the lighting and/or irrigation of the plants being cultivated. Disadvantageously, this makes them overly complicated for home use or as a hobby, where the user may not be as expert as the farmer.

In other words, there is a strongly-felt need for a device for hydroponic cultivation that is within everyone's reach, for domestic use by non-professionals, such as a homemaker for example, or for use in the restaurant sector where the restaurant service staff involved has skills other than those related to hydroponics and needs a tool that is simple, easy to use and efficient.

The document EP 0 804 873 A1 (an abandoned patent application) discloses a method for growing a plant and a device therefor.

The device includes a container containing water or a nutrient liquid, having a bottom wall and a side wall, a removable cover having an opening, a basket suspended from the opening so as to hold a plant, and a sparger comprising an air pump mounted on the cover.

Disadvantageously, the pump, that is, the electromechanical instrument constituting it, is arranged at the same level as the plant support. This is the cause of a condition constituting serious risk in the use of the device, this risk being determined by the possibility of the fluid contained in the container or the moisture present in and around the support coming into contact with this instrument.

This device can prove to be even more dangerous, particularly in the domestic environment under conditions of possible contact with less expert users.

On the other hand, the EP 0 804 873 does not provide for the possibility that the relative arrangement of the pump and the support can be changed either.

Furthermore, the device appearing in EP 0 804 873 does not appear to be utilizable in any manner whatsoever in a domestic environment, by non-professional users, given that it is not equipped with any sort of user-friendly control interface.

The need is also felt for the cultivation of crops that are not affected by contaminated soils or that can be attacked by microorganisms that make the use of pesticides necessary, resulting in an alteration of the quality of the crop.

In this context, the technical task underlying the present invention is to offer a device for domestic hydroponic cultivation that overcomes the drawbacks of the prior art mentioned hereinabove.

Specifically, the aim of the present invention is to make available a device for domestic hydroponic cultivation that is simple to use and versatile.

The defined technical task and the specified aims are substantially achieved by a device for domestic hydroponic cultivation comprising the technical characteristics recited in one or more of the appended claims.

With respect to the prior art, the invention achieves the following principal advantages:
It can be easily used by non-professional users, such as homemakers, or by service staff, in the event that the device is used in restaurants.
It does not require the presence of soil for crop cultivation; it does not even require pesticides or chemical products capable of ensuring the growth of a plant in soil; it does not require GMO solutions to combat harmful parasites or microorganisms, thereby ensuring aseptic conditions of cultivation.

Further characteristics and advantages of the present invention will become more apparent from the approximate, and thus non-limiting, description of a preferred, but not exclusive embodiment of a device for domestic hydroponic cultivation, as illustrated in the accompanying drawings, in which:

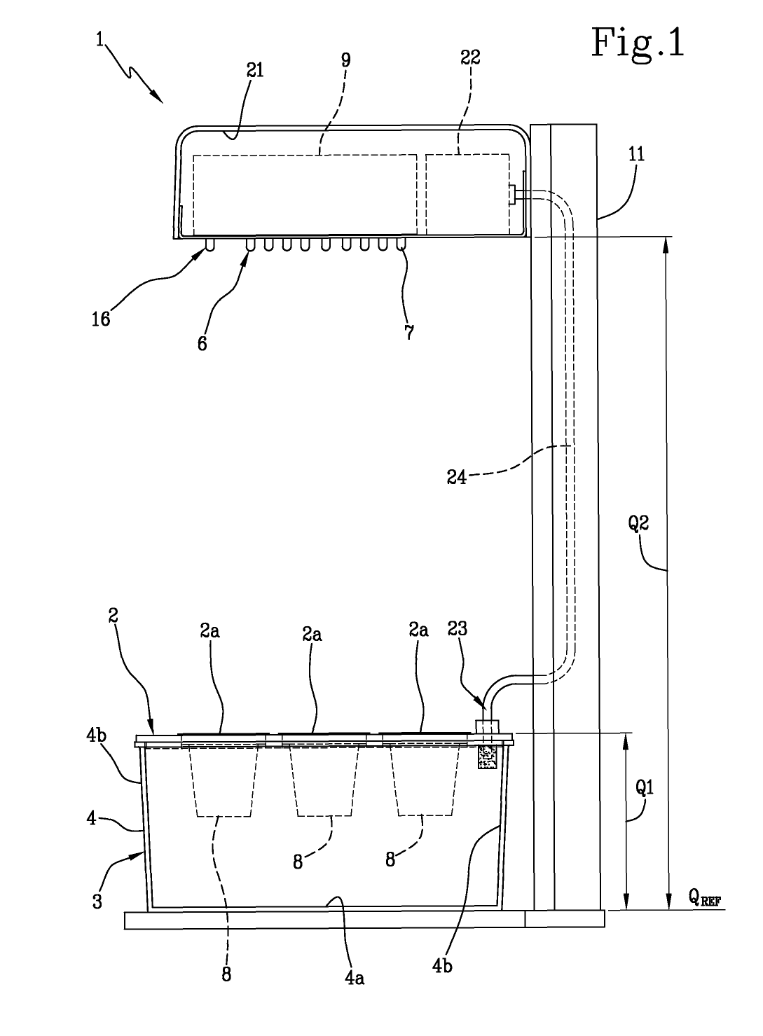

FIG. 1 is a lateral sectional view of a device for domestic hydroponic cultivation according to the present invention;

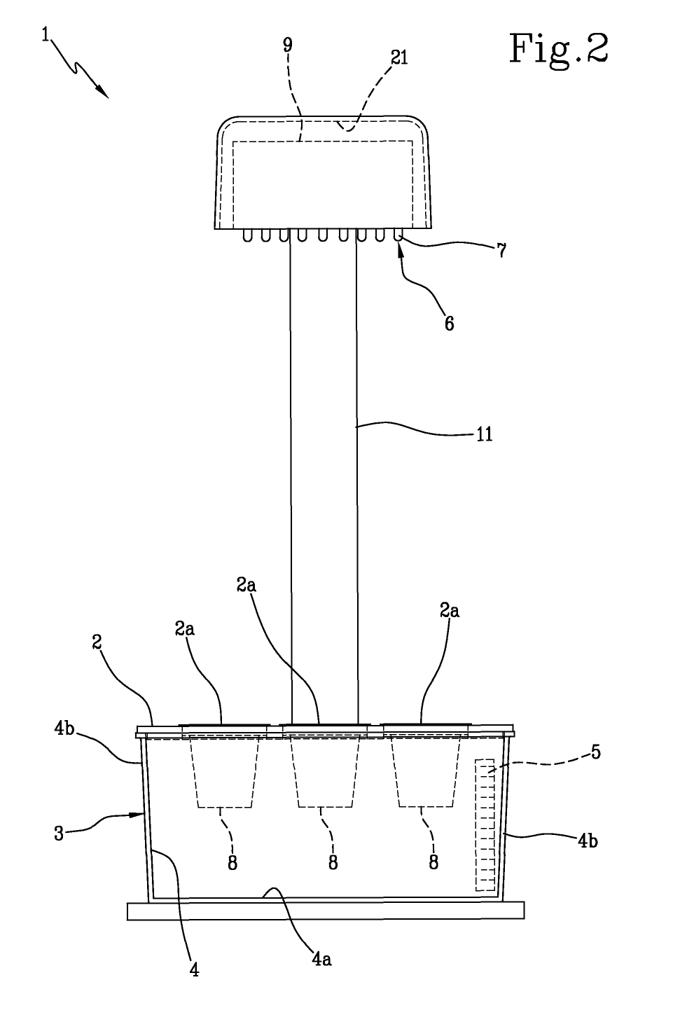

FIG. 2 is a front sectional view of the device appearing in FIG. 1;

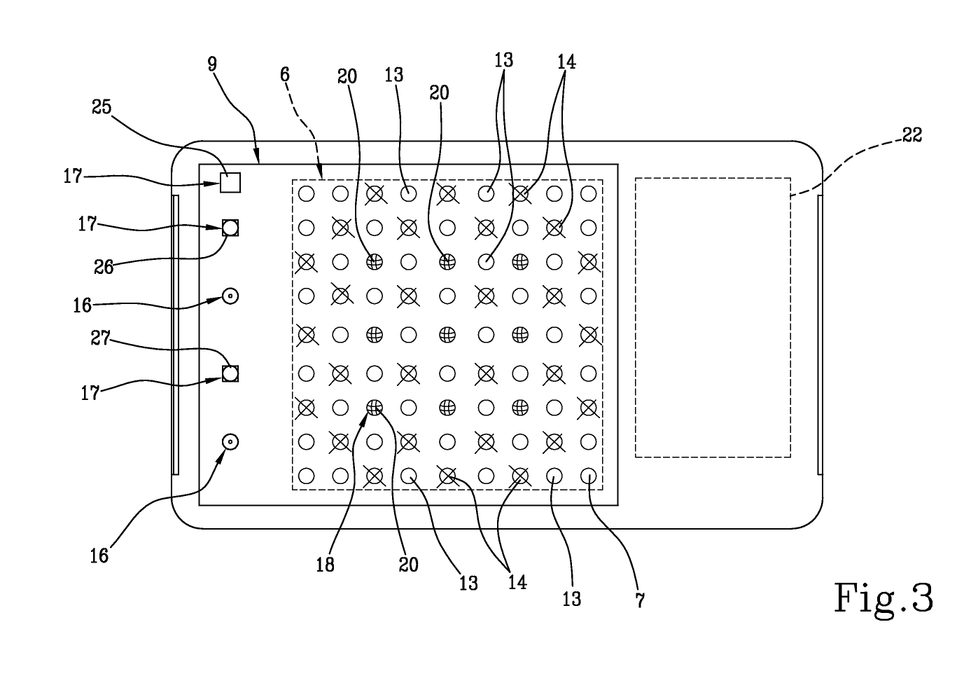

FIG. 3 is a view from below of a detail of the device appearing in FIGS. 1 and 2;

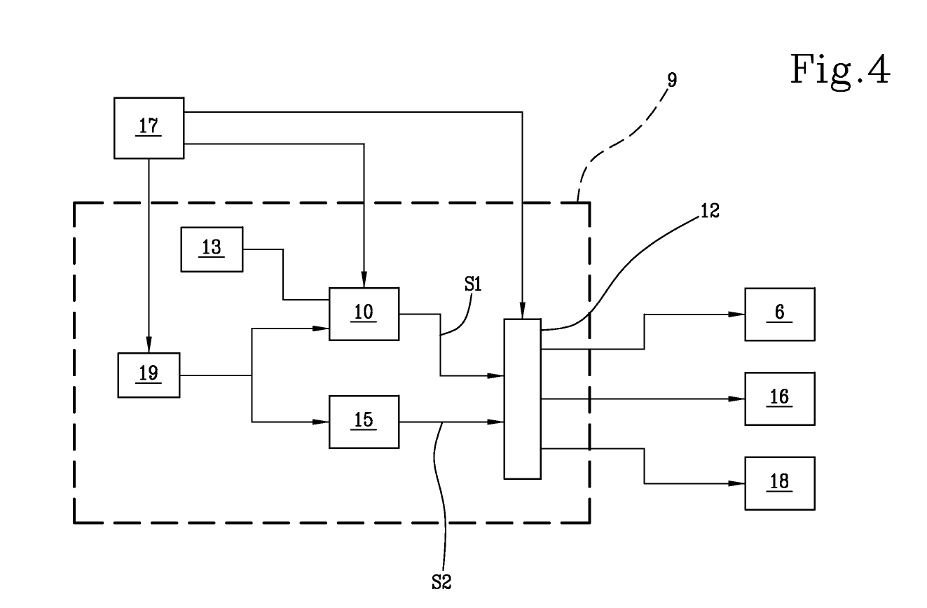

FIG. 4 is a block diagram representing the operation of the device appearing in FIGS. 1 and 2.

With reference to the attached figures, a device for domestic hydroponic cultivation according to the present invention is indicated by the number 1. The device 1 comprises housing means 2, 3 configured to house at least one plant.

The housing means 2, 3 comprise a reservoir 3 for containing a nutrient fluid for at least one plant; the reservoir 3 is positioned at a predetermined reference height Qref in the device of the invention.

It is understood that the predetermined reference height Qref is a height representative of the base supporting the reservoir 3 and therefore of the base supporting the device 1 of the invention.

The housing means 2, 3 comprise a support 2 configured to receive the at least one plant.

According to the invention, the support 2 is removably associated with the upper part of the reservoir 3, particularly with a first height Q1 that is higher than the predetermined reference height Qref.

Specifically, the support 2 has at least one concavity 2a in which a plant, and possibly a supporting substratum (not illustrated) can be inserted.

The function of the reservoir 3 is to contain a nutrient fluid. The nutrient fluid can be a solution of water and nutrients, specifically suited to the type of plant being cultivated.

By way of example, the nutrient fluid may consist solely of tap water.

In one embodiment, the nutrient fluid can be obtained by adding a fertilizer to the tap water.

In further detail, the reservoir 3 comprises a tub 4 having a bottom 4a and walls 4b. The cited support 2 overlies the reservoir 3, particularly the tub 4. In other words, the support 2 serves as a cover for the reservoir 3, in that it covers the tub 4. Note that the support 2 can be removed from the tub 4, so that this tub 4 can be filled with the nutrient fluid.

Advantageously, according to the invention, changing the water does not require particular care and/or skills and it can be carried out by anyone, professionals and non-professionals, as is the case with a normal coffee maker.

The reservoir 3 comprises a graduated scale 5 afforded on the tub 4 and specifically on one of the walls 4b thereof. Advantageously, this graduated scale 5 enables quick reading of the amount of nutrient fluid present inside the reservoir 3.

In other words, even the inexperienced user is able to become immediately aware of the amount of water remaining in the reservoir.

Note also that the support 2 has at least one screen 8 located at the concavity 2a. This screen is advantageously set inside the above-mentioned tub 4. During operation of the device 1, the nutrient fluid is absorbed by the plant through this screen 8.

To mix and aerate the nutrient fluid, the device 1 comprises means for supplying air 22, 23, which are also configured so as to ensure an aseptic state of the nutrient fluid.

These means for supplying air comprise a pump 22 associated with the reservoir 3. Specifically, the function of the pump 22 is to introduce air inside the tub 4.

In further detail, the pump 22 is connected to a bubbler 23, preferably through a tube 24 for the passage of air.

According to the invention, the bubbler 23 is associated with the support 2 substantially at a first height Q1.

More specifically, the bubbler 23 is mounted on the support 2 substantially at the first height Q1.

It is understood that the end of the bubbler 23 may be in the proximity of the support 2 or, alternatively, may not be in the proximity of this support 2. Specifically, in this latter case, the tube 24 passes through the support 2.

Even more specifically, the tube 24 can reach the bottom of the reservoir 3, substantially at the predetermined reference height Qref.

The bubbler makes it possible to ensure an aseptic state during cultivation because it prevents the entry of undesirable bacteria, microbes and yeasts.

When the user empties the reservoir 3, after lifting the support 2, the bubbler 23 is lifted solidly constrained to the support 2.

This allows even the inexperienced user to fill the reservoir 3 without detaching the bubbler 23 and having to deal with possible water leakage from the connected tube, as is the case in the prior art, where the bubbler is positioned on the bottom of the reservoir 3. Moreover, the user's hands are free for changing the water, as there is no need to detach the bubbler from the reservoir, as is the case in embodiments of the prior art.

Advantageously, according to the invention, positioning the bubbler 23 at the height of the support 2 prevents the backflow of water in the tube 24, which would occur by virtue of the principle of communicating vessels if the bubbler were positioned on the bottom of the reservoir 3 or in any case, below the support 2; this position would also make it necessary to carry out a procedure with the pump 22 to drain the tube 24 of the water that has needlessly entered it. All of this would go against the principle of simplicity, which is a primary principle characterizing the device of the present invention.

Advantageously, according to the invention, the pump 22 is positioned in the device 1 at a second height Q2, higher than the first height Q1 and the predetermined reference height Qref.

The device 1 of the invention further comprises lighting means. Lighting means 6 are associated with the support 2, in such a manner as to supply adequate light to the plant being cultivated, it being adequate in terms of intensity and in terms of the duration of exposure.

In other words, these lighting means 6 are configured to illuminate the at least one plant.

The lighting means 6 comprise a plurality of LEDs 13, 14, each LED 13, 14 being configured to emit light radiation having a wavelength within the range of 420 to 460 nm or within the range of 630 to 670 nm.

Specifically, the lighting means 6 comprise at least one light source 7 facing the support 2 so as to enable light to be emitted towards the support 2. Specifically, as shown in FIG. 1, the light source 7 is located above the support 2, that is, at a height higher than the first height Q1.

In further detail, the light source 7 is connected to the support 2 preferably through a rod 11. This rod 11 is arranged transversely, and preferably perpendicularly, with respect to a horizontal plane. The pump 22 described above is arranged in a compartment 21 afforded above the light source 7. Advantageously, this makes it possible to arrange all the electrically powered components away from the reservoir 3, specifically above it. It is understood that all the electrically powered components are found above the at least one plant and above the support 2 that is configured to receive the at least one plant. Dangerous short circuits that could occur should the nutrient fluid or the moisture present on the support 2 come in contact with or affect the electrically powered components are thus prevented.

Therefore, the technical effect of an arrangement of the electrically powered components such as this consists in the guarantee of the absence of any type of interaction between the sources of electricity and the moisture/fluid associated with the at least one plant.

Furthermore, these components are advantageously supplied by an external power supply unit (not illustrated) preferably in alternating current and even more preferably at a voltage of 12 V.

The further technical effect achieved ensures user safety as determined by the fact that possible dispersion of current on the part of the components powered at that voltage is almost negligible; this contributes to the conformity of the device of the invention for use in a domestic environment in which even the most inexperienced user runs no risk.

Note that the light source 7 can be switched between a configuration for operation in which it is locked on the rod 11 and a configuration for adjustment in which it is slidable on the rod 11. Advantageously, this makes it possible to change the distance between the light source 7 and the support 2, so as to change the intensity of incident light on the support 2 and adapt it to the plant to be cultivated.

In other words, in the device of the invention, the second height Q2 can be changed according to the type of the at least one plant received by the support 2, so as to simulate the proper lighting conditions for any plant present in the support 2.

As mentioned previously herein, the lighting means 6, particularly the light source 7, comprise a plurality of LEDs 13, 14.

In further detail, the light source 7 comprises a plurality of red LEDs 13, configured to emit light radiation having a wavelength within the range of 630 to 670 nm, particularly equal to 650 nm. Likewise, the light source 7 comprises a plurality of blue LEDs 14, configured to emit light radiation having a wavelength within the range of 420 to 460 nm, preferably equal to 440 nm.

The use of LEDs 13, 14 advantageously contributes to cutting energy consumption. Even more advantageously, the combination of the red and blue colours makes it possible to maximize the emission of light in the areas of the spectrum utilized by plants for photosynthesis, thereby contributing to the optimization of energy consumption levels.

The device 1 further comprises auxiliary lighting means 18 associated with the support and configured to illuminate the plant. Specifically, these auxiliary lighting means 18 can be activated or deactivated directly by a user. In further detail, the auxiliary lighting means 18 comprise one or more white LEDs 20. Advantageously, this makes it possible to view the actual colour of the plant and for example to visually check its growth and state of health.

The device 1 further comprises a control unit 9, which is associated with the lighting means 6.

This control unit 9 is specifically configured to command the activation and/or deactivation of the lighting means 6.

According to the invention, the control unit 9 is advantageously mounted in the device 1 of the invention at a height higher than the second height Q2. This makes it possible to prevent any disadvantageous interaction between the fluid contained in the reservoir and the control unit.

The technical effect of an arrangement of the control unit 9 such as this consists in the guarantee of the absence of any type of interaction between sources of electricity/electronic circuits and the moisture/fluid associated with the at least one plant. A technical effect such as this is synergistic with the technical effect achieved by the positioning of the pump 22 and the electrically powered components as described hereinabove. This ensures the absolute safety of the device of the invention, particularly for less experienced users, which is commonly the case with use in the domestic environment.

According to the invention, the control unit 9 is advantageously configured to command the activation and/or deactivation of the lighting means 6 according to a pre-established timetable.

Specifically, but not exclusively, the control unit 9 is configured to control in an accurate manner a simulation of a day/night cycle under conditions of different seasons, through simple settings that can be selected by means of a special user interface.

Additionally, but not exclusively, the control unit 9 is configured to control in an accurate manner a timing of the topping up or replacement of the nutrient fluid inside the reservoir, through simple settings that can be selected by means of a special user interface.

In general, it should be noted that in the present context and in the claims that follow, the control unit 9 is described as being subdivided into distinct functional modules (memory modules or operating modules) for the sole purpose of describing its functions clearly and completely.

This control unit 9 can actually be constituted by a single electronic device, suitably programmed to perform the described functions, and the various modules can correspond to hardware entities and/or routine software that are part of the programmed device.

Alternatively or additionally, these functions can be performed by a plurality of electronic devices on which the above-mentioned function modules can be distributed.

The control unit 9 can use one or more processors for the execution of the instructions contained in the memory modules. Moreover, the above-mentioned function modules can be distributed on various local or remote computers based on the architecture of the network in which they are located.

As shown particularly in FIG. 3, the control unit 9 comprises a printed circuit board housed in the compartment 21 and arranged specifically above the lighting means 6.

In detail, the control unit 9 comprises a first timing module 10 configured to measure a first pre-established time interval “T1” and generate a signal S1 representative of a status of the lighting means 6 at the end of this first time interval “T1”. In other words, the first timing module 10 marks the passage of time, emitting the signal S1 with each interval.

The control unit 9 further comprises an operating module 12. Specifically, this operating module 12 is associated with the first timing module 10 and it is configured to detect the output signal S1 from the first timing module 10 and to activate/deactivate the lighting means 6 in accordance with the signal S1.

Specifically, the first timing module 10 is configured to measure an activation interval “TA” and a deactivation interval “TD” of the cited lighting means 6.

Specifically, in a first operating configuration of the timing module 10, the activation interval “TA” consists of 17 hours, whereas the deactivation interval “TD” consists of 7 hours.

In a second operating configuration, both the activation and the deactivation interval consist of 12 hours each.

In the preferred embodiment, the activation and deactivation intervals can be selected by the user. In other words, the user can switch the first timing module 10 from the first to the second operating configuration. Advantageously, this makes it possible to simulate a day/night cycle accurately, under spring season conditions and under summer season conditions.

In other words, any user without specific technical expertise can set a program for the day/night cycle of their choice, without any difficulty.

In addition or as an alternative to the configurations described above, the user can insert specific lengths of time for the activation and deactivation intervals, so as to adapt them to their own specific needs.

In this regard, there can be provided a compatibility table TC that allows the user to choose the best day/night program based on the plant the user wants to cultivate. This compatibility table is provided in a memory module 13 associated with the control unit 9.

In greater detail, the signal S1 can be an analogue or digital signal. In a first embodiment of the invention, the signal S1 is transmitted continuously and it contains information on the status one wants to assign to the lighting means 6. By way of example only, this signal can contain a value equal to 0 (that is, it can be deactivated) so as to command the deactivation of the lighting means 6. The signal S1 may have a value equal to 1 so as to signal the activation of the lighting means 6.

In an alternative embodiment of the invention, the signal S1 can take on intermediate values, representative of a change in the luminosity of the lighting means 6. By way of example, this change in luminosity can be achieved by switching on only some of the cited LEDs 13, 14.

In a further embodiment of the invention, the signal S1 can be an impulse type of signal, and thus be emitted only at the end of the activation and deactivation intervals. In this case, the signal S1 contains no indication of the status of the lighting means, but it signals only the need to switch between activation and deactivation. In other words, in this embodiment, the operating module 12 is a simple switch.

The control unit 9 further comprises a second timing module 15. This second timing module 15 is configured to measure a second pre-established time interval “T2” and generate a signal S2 at the end of this second time interval “T2”. This second time interval “T2” preferably consists of 14 days. In one embodiment of the invention, this second time interval “T2” can be set by the user, in the same manner as the first time interval “T1” mentioned hereinabove.

In other words, the inexperienced user has at his/her disposal an instrument that without any difficulty involved in its use, enables him/her to keep the length of time that the nutrient fluid remains in the reservoir under control.

The device 1 further comprises a display means 16, configured to detect the signal S2 and signal the end of the second time interval “T2” to the user. In further detail, the signal S2 is processed by the cited operating module 12, which commands the activation of the display means 16. By way of example, the display means 16 can consist of an indicator light or a LED that is functionally distinct from the lighting means 6.

Advantageously, it is possible in this manner to provide a warning for the user to perform a procedure needed for maintaining the plant being cultivated, including for example the topping up or replacement of the nutrient fluid inside the reservoir so as to change the nutrient fluid inside said reservoir 3.

As mentioned previously, in this case as well, this procedure does not require any special technical expertise on the part of the user.

The device 1 further comprises an interface 17 associated with the control unit 9. Specifically, the interface 17 is associated with the first timing module 10. Additionally or alternatively, the interface 17 is associated with the second timing module 15, as is schematically shown in FIG. 4. The interface 17 is specifically configured to set a starting time for the measurement of the first “T1” and/or second pre-established time interval “T2”.

The interface 17 is extremely “user friendly”; in other words, setting the commands described can be carried out in a simple manner by all users, even inexperienced users.

In greater detail, the control unit comprises a resetting module 19 associated with the timing modules 10, 15. This resetting module detects a resetting command preferably from the interface 17, and provides for restarting the count of the first “T1” and/or second time interval “T2”. Advantageously, this makes it possible for example to synchronize the operating cycle of the lighting means 6 with the user's day/night cycle.

Note also that the interface 17 is associated with the auxiliary lighting means 18 in such a manner as to activate and/or deactivate them.

The interface 17 comprises a plurality of pushbuttons 25, 26, 27, which are shown in detailed form in FIG. 3.

Purely by way of example, a first pushbutton 25 can switch the configurations of the first timing module 10. In other words, in an immediate manner, the first pushbutton 25 allows the user to activate a timer for timing the length of the day/night cycle.

A second pushbutton 26 can command the resetting module 19. In other words, in an immediate manner, the second pushbutton 26 allows the user to reset the timer for timing the length of the day/night cycle, so it can be reset with new values.

A third pushbutton 27 provides for activation/deactivation of the auxiliary lighting means 18. In other words, in an immediate manner, the third pushbutton 27 allows the user to activate/deactivate the white LEDs 20, for the purpose of viewing the actual colour of the plant.

These pushbuttons 25, 26, 27 can send the respective commands following the immediate pressing/release thereof, or more preferably, following prolonged pressing thereof for predetermined number of seconds (e.g. 5 seconds).

In an alternative embodiment, the user interface 17 can be configured as a display, possibly a touchscreen display, in which the functions of the pushbuttons 25, 25, 27 are achieved by touching the screen, thereby enabling quick intuitive selection of the desired option.

The present invention resolves the stated technical problem. Specifically, the control unit is in charge of management of the lighting, and provides for reminding the user to replenish the nutrient fluid. Furthermore, the control unit can be managed by means of a few simple commands, within the reach of the “hobbyist” user as well.

The present invention also achieves significant advantages. Specifically, the device has extremely low energy consumption levels (approximately 9 W) mainly owing to the use of LED lights, as well as other measures aimed at minimizing energy consumption.

The use of a pump with a bubbler also makes it possible to keep the noise level of the device low.

1-13. (canceled)

14. A device (1) for domestic hydroponic cultivation, comprising:
housing means (2, 3) configured to house at least one plant, wherein said housing means (2, 3) comprise:
a reservoir (3) for containing a nutrient fluid for said at least one plant, said reservoir (3) being positioned at a predetermined reference height (Qref);
a support (2) configured to receive said at least one plant, wherein said support (2) is removably associated with the upper part of said reservoir (3) at a first height (Q1) that is higher than said predetermined reference height (Qref);
means for supplying air (22, 23) configured so as to ensure an aseptic state of said nutrient fluid and comprising:
a pump (22) associated with said reservoir (3) and positioned in said device (1) at a second height (Q2) that is higher than said first height (Q1) and said predetermined reference height (Qref);
a bubbler (23) associated with said support (2);
lighting means (6) associated with said support (2), configured to illuminate said at least one plant and comprising a plurality of LEDs (13, 14), each LED (13, 14) being configured to emit light radiation having a wavelength within the range of 420 to 460 nm or within the range of 630 to 670 nm;
a control unit (9) mounted in said device (1) at a height higher than said second height (Q2), said control unit (9) being associated with said lighting means (6) and configured to command the activation and/or deactivation thereof.

15. The device (1) for domestic hydroponic cultivation according to claim 14, wherein said second height (Q2) can be changed according to the type of said at least one plant received by said support (2), so as to simulate the proper lighting conditions for any said at least one plant in said support (2).

16. The device (1) for domestic hydroponic cultivation according to claim 14, wherein said control unit (9) is configured to command the activation and/or the deactivation of said lighting means (6) according to a pre-established timetable.

17. The device (1) for domestic hydroponic cultivation according to claim 15, wherein said control unit (9) is configured to command the activation and/or the deactivation of said lighting means (6) according to a pre-established timetable.

18. The device (1) according to claim 16, characterized in that said control unit (9) comprises a first timing module (10) configured to measure a first pre-established time interval (T1) and generate a signal (S1) representative of a status of said lighting means (6) at the end of said first time interval (T1); an operating module (12) configured to detect said signal (S1) and activate/deactivate said lighting means (6) in accordance with said signal (S1), said operating module (12) thereby realizing a day/night simulation for said at least one plant received by said support (2).

19. The device (1) according to claim 17, characterized in that said control unit (9) comprises a first timing module (10) configured to measure a first pre-established time interval (T1) and generate a signal (S1) representative of a status of said lighting means (6) at the end of said first time interval (T1); an operating module (12) configured to detect said signal (S1) and activate/deactivate said lighting means (6) in accordance with said signal (S1), said operating module (12) thereby realizing a day/night simulation for said at least one plant received by said support (2).

20. The device (1) according to claim 18, characterized in that said first timing module (10) is configured to measure an activation interval (TA) of said lighting means (6) and a deactivation interval (TD) of said lighting means (6); said activation and deactivation intervals being selectable and/or settable by a user.

21. The device (1) according to claim 19, characterized in that said first timing module (10) is configured to measure an activation interval (TA) of said lighting means (6) and a deactivation interval (TD) of said lighting means (6); said activation and deactivation intervals being selectable and/or settable by a user.

22. The device (1) according to claim 14, characterized in that said control unit (9) comprises a second timing module (15) configured to measure a second pre-established time interval (T2) and generate a signal (S2) at the end of said second time interval (T2); display means (16) configured to detect said signal (S2) and signal the end of said second time interval (T2) to the user so as to warn the user that the nutrient fluid inside said reservoir needs to be changed.

23. The device (1) according to claim 18, characterized in that said control unit (9) comprises a second timing module (15) configured to measure a second pre-established time interval (T2) and generate a signal (S2) at the end of said second time interval (T2); display means (16) configured to detect said signal (S2) and signal the end of said second time interval (T2) to the user so as to warn the user that the nutrient fluid inside said reservoir needs to be changed.

24. The device (1) according to claim 19, characterized in that said control unit (9) comprises a second timing module (15) configured to measure a second pre-established time interval (T2) and generate a signal (S2) at the end of said second time interval (T2); display means (16) configured to detect said signal (S2) and signal the end of said second time interval (T2) to the user so as to warn the user that the nutrient fluid inside said reservoir needs to be changed.

25. The device (1) according to claim 14, characterized in that it comprises an interface (17) associated with said control unit (9), particularly with a first (10) and/or second timing module (15), and configured to set a starting time for the measurement of a first (T1) and/or second pre-established time interval (T2).

26. The device (1) according to claim 14, characterized in that it comprises auxiliary lighting means (18) associated with the support (2) and configured to illuminate said plant, said auxiliary lighting means (18) being directly activatable and/or deactivatable by a user.

27. The device (1) according to claim 20, characterized in that it comprises auxiliary lighting means (18) associated with the support (2) and configured to illuminate said plant, said auxiliary lighting means (18) being directly activatable and/or deactivatable by a user.

28. The device (1) according to claim 21, characterized in that it comprises auxiliary lighting means (18) associated with the support (2) and configured to illuminate said plant, said auxiliary lighting means (18) being directly activatable and/or deactivatable by a user.

29. The device (1) according to claim 27, characterized in that an interface (17) is associated with auxiliary lighting means (18) for the activation and/or deactivation thereof.

30. The device (1) according to claim 29, wherein said interface (17) comprises one or more of the following:
a first pushbutton (25) configured to switch the configurations of a first timing module (10);
a second pushbutton (26) configured to command a resetting module (19);
a third pushbutton (27) configured to provide for the activation/deactivation of said auxiliary lighting means (18).

31. The device (1) according to claim 14, characterized in that said bubbler (23) is mounted on said support (2).

32. The device (1) according to claim 14, characterized in that said pump (22) is connected to said bubbler (23) through a tube (24) for the passage of air.

33. The device (1) according to claim 31, characterized in that said pump (22) is connected to said bubbler (23) through a tube (24) for the passage of air.

34. The device (1) according to claim 32, characterized in that said tube (24) passes through said support (2).

35. The device (1) according to claim 33, characterized in that said tube (24) passes through said support (2).
